(19) United States
(12) Patent Application Publication
(10) Pub. No.: US 2026/0244423 A1
(43) Pub. Date: Aug. 20, 2026

(54) SYSTEM AND METHOD FOR LEVERAGING LARGE LANGUAGE MODELS TO DETECT APPLICATIONS INSTALLED ON A COMPUTING SYSTEM

(71) Applicant: EON IO Ltd., Tel Aviv (IL)

(72) Inventors: Benjamin Gruenbaum, Herzliya (IL); Yair Weiss, Givatayim (IL); Assaf Natanzon, Tel Aviv (IL); Ofir Ehrlich, Tel Aviv (IL); Ron Kimchi, Tel Aviv (IL); Ilya Surdin, Ramat Gan (IL)

(73) Assignee: EON IO Ltd., Tel Aviv (IL)

(21) Appl. No.: 19/055,766

(22) Filed: Feb. 18, 2025

(51) Int. Cl. G06F 8/61

(52) U.S. Cl. CPC G06F 8/61

(57) ABSTRACT

In one embodiment, a method comprises receiving, from a plurality of large language models, a first plurality of application detectors for a plurality of applications, wherein an application detector comprises executable code to detect whether an application is installed on a computing system; executing the first plurality of application detectors to determine whether the first plurality of application detectors accurately detect applications installed on a plurality of computing systems; and selecting, based on detection accuracy of the first plurality of application detectors, a second plurality of application detectors to deploy for use in detecting the plurality of applications.

### TECHNICAL FIELD

This disclosure relates in general to the field of computing, and more particularly, to a system and method for leveraging large language models to detect applications installed on a computing system.

### BACKGROUND

Application backup is the process of creating and storing copies of applications and associated data in a remote, cloud-based environment to ensure application data availability, protection, and recovery in case of failure or data loss. While organizations may utilize traditional on-premises backups, cloud backups offer greater flexibility and scalability, allowing businesses to adjust storage as needed and access their application data from anywhere with an internet connection. Cloud backups typically provide automated processes, encryption, and redundancy across multiple servers, enhancing both security and reliability. This ensures that businesses can recover their applications and data quickly, minimizing downtime and mitigating the risk of data breaches or corruption.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a block diagram of a cloud backup environment, in accordance with any of the embodiments disclosed herein.

FIG. 2 illustrates a block diagram of a backend of a cloud backup service provider of the environment of FIG. 1, in accordance with any of the embodiments disclosed herein.

FIG. 3 illustrates a block diagram of a computing system of FIG. 1, in accordance with any of the embodiments disclosed herein.

FIG. 4 illustrates a flow for generating application installers for an application, in accordance with any of the embodiments disclosed herein

FIG. 5 illustrates a flow for generating a functional application detector for an application, in accordance with any of the embodiments disclosed herein.

FIG. 6 illustrates a flow for generating application installers and application detectors, in accordance with any of the embodiments disclosed herein.

FIG. 7 illustrates a flow for utilizing application detectors to perform application backup, in accordance with any of the embodiments disclosed herein.

### DETAILED DESCRIPTION OF EXAMPLE EMBODIMENTS

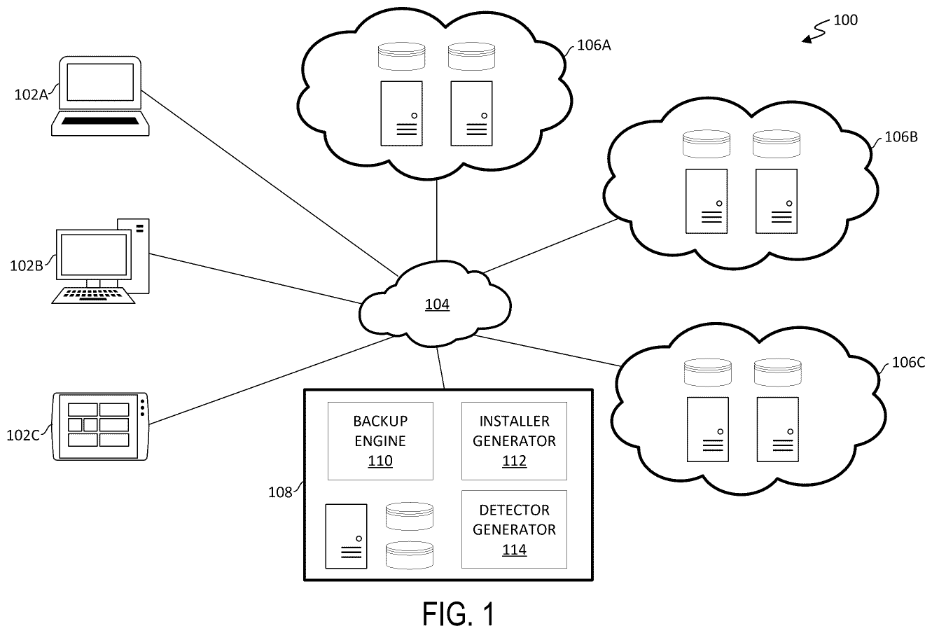

FIG. 1 illustrates a block diagram of a cloud backup environment 100, in accordance with any of the embodiments disclosed herein. An organization (e.g., any one or more users associated with each other) may be associated with any number of computing systems 102 (e.g., 102A, 102B, 102C) that are utilized by users associated with the organization. Each computing system 102 may have any number of applications installed thereon and each application may have associated application data. Application data for a particular application may refer to data (e.g., files) associated with the application that supports execution of the application (e.g., executable files, configuration files, application state) or data generated by the application (e.g., data files).

Backup software may be used to create copies of application data to prevent data loss in case of failures, corruption, or accidental deletions. Application backup usually includes identifying applications that are to be backed up, capturing the application data to be backed up, and storing the captured data in a secure location (e.g., on-premises, in the cloud, on external storage devices, etc.). The backup procedure may be performed regularly to enable recovery of application data that is up to date. In the event of data loss, the backup software can restore the application data to its previous state.

Application backup may be distinguished from virtual machine (VM) backup. While application backup may focus on backing up individual applications and their data, it may capture only the necessary files and configurations related to the application (or any suitable selection of the application data), whereas VM backup may involve backing up the entire virtual machine, including the operating system, applications, and all data within the VM. Thus, application backup may be more granular and flexible (as specific applications and types of application data may be targeted), allowing for quicker backups and restores of individual applications and utilizing less backup storage resources relative to VM backup. In contrast, VM backup may enable a complete system backup that is useful for full system recovery.

Utilizing application backup, application data of one or more of the computing systems 102 or other computing systems (e.g., physical computing systems or virtual computing systems, such as virtual machines, containers, virtual desktops, etc.) may be periodically backed up at a site owned or leased by the organization (e.g., “on premises”), at another location (e.g., owned or managed by a cloud service provider), or at multiple locations. In various embodiments, the application data may be backed up in the cloud, e.g., within a backend 106 (e.g., 106A, 106B, 106C) of a cloud backup service provider, across multiple backends of the same cloud backup service provider, at one or more backends of a different cloud backup service provider, at another suitable location (e.g., at a local site of the organization), or any combination thereof (e.g., some application data may be backed up at backend 106A, other application data may be backed up at backend 106B, and some application data may be backed up at a local site).

In order to perform application backup, backup and restore system 108 (or other backup system comprising logic performing the backup) may first detect applications that are installed on a computing system 102 or other computing system being backed up. A backup system may detect applications through various methods, depending on the type of backup software and the environment in which it operates. For example, a backup system may utilize agent-based detection, wherein agents are installed on the computing system and the agents detect installed applications by scanning the computing system (e.g., some backup agents include application specific plugins designed to detect and interact with certain applications such as databases and email servers). As another example, a backup system may scan configuration files (e.g., config.yaml, application.properties) to identify applications and their settings. On computing systems running Microsoft Windows, the backup system may query the Windows Registry to detect installed applications. As another example, a backup system may monitor running services to detect applications. For example, the backup system can check for services such as mysqld for the MySQL application or httpd for the Apache application. By scanning running processes, backup systems may identify applications based on known process names and paths. As another example, for cloud-based and virtualized environments, backup systems may use application programming interfaces (APIs) provided by cloud providers or virtualization platforms (e.g., VMware, Hyper-V) to detect applications. Some applications provide APIs that backup software can use to query the application directly for its presence and status. In another example, a backup system may scan a file system of a computing system for known directory structures and file patterns associated with specific applications. For example, file metadata and headers may be examined to identify files specific to a particular application. As another example, an administrator may manually configure the backup system to look for specific paths, services, or other identifiers in order to detect specific applications.

As the number of available applications grows (e.g., a backup system may support detection of hundreds, thousands, or more applications), the detection of applications becomes complex and tedious, requiring significant manual labor to design a backup system with detectors for the vast number of available applications. However, detection of applications on a computing system may be very beneficial (regardless of whether application backup or full VM backup is used) to allow users to know and/or select which applications are being backed up and where the backups are stored.

In various embodiments of the present disclosure, systems and methods for leveraging large language models (LLMs) to detect applications installed on a computing system are provided. At least some of these systems and methods may improve application detection through an adversarial process. In various embodiments, various LLMs may be utilized to generate application installers and application detectors. The generated installers and detectors may be tested for suitability (e.g., to make sure the installers successfully install the applications and to make sure the detectors detect the correct applications without detecting false positives) and then selected detectors may be deployed in the backup system to detect installed applications.

Various embodiments of the present disclosure may provide one or more technical advantages such as faster detection of applications, a reduction in time and computing resources spent generating or updating detectors, or other technical advantages.

In the depicted embodiment, the cloud backup environment 100 includes a backup and restore system 108. The backup and restore system 108 may provide any suitable features of application data backup and restoration described herein. In various embodiments, the backup and restore system 108 may also perform any suitable operations of the installer and detector generation and testing (or other logic of any suitable one or more computing systems may perform such operations and provide the detectors to the backup and restore system 108 for use in backup or other operations). In other embodiments, any of these features or a subset thereof may be performed by any other suitable logic, such as computing systems within one of the backends 106, by a computing system 102 (e.g., through a web application or native application that interfaces with the backup and restore system 108), or by other suitable logic.

Backup and restore system 108 may include any suitable number of computing systems to perform the functions described herein. In a particular embodiment, the backup and restore system 108 may comprise a cluster of nodes (e.g., physical or virtual machines) in a Kubernetes environment, although any suitable computing environment may be used to implement the backup and restore system 108. The backup and restore system 108 may include and/or manage a plurality of accounts, where a particular account may be associated with (e.g., owned or controlled by) a particular organization. Data used to provide application data backup for a particular organization may be stored in the account owned by that organization. In various embodiments, the backup and restore system 108 may be separate from the backends 106 or could be implemented (at least in part) within one of the backends 106.

Computing systems 102 may include any electronic computing system operable to receive, transmit, process, and store any appropriate data. In various embodiments, computing systems 102 may be mobile devices or stationary devices. As examples, mobile devices may include laptop computers, tablet computers, smartphones, personal digital assistants, and other devices capable of connecting (e.g., wirelessly) to network 104 while stationary devices may include desktop computers or other devices that are not easily portable. Computing systems 102 may include a set of programs such as operating systems (e.g., Microsoft Windows, Linux, Android, Mac OSX, Apple iOS, UNIX, or other operating system), applications, and other software-based programs capable of being run, executed, or otherwise used by the respective devices. A computing system may include at least one graphical display and user interface allowing a user to view and interact with applications and other programs of the computing system.

FIG. 1 also depicts a network 104 that couples the computing systems 102, backends 106, and backup and restore system 108 together. The network 104 may transport communications between computing systems 102, the various backends 106, and the backup and restore system 108.

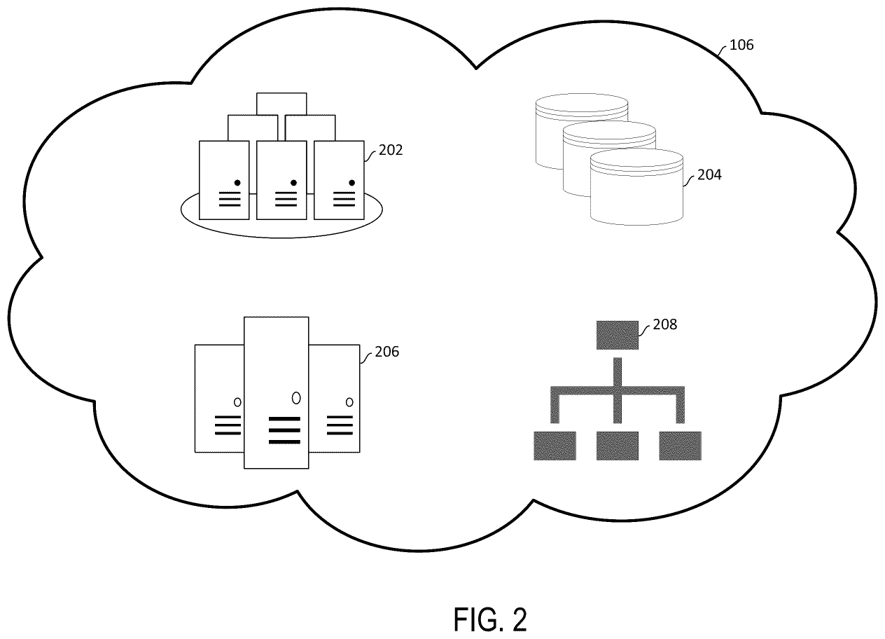

FIG. 2 illustrates a block diagram of a backend 106 of a cloud backup service provider of the environment of FIG. 1, in accordance with any of the embodiments disclosed herein. Backend 106 may include various computing systems to provide services (including database backup services) to various organizations. In the embodiment depicted, backend 106 includes compute resources 202, storage resources 204, operations computing systems 206, and networking resources 208.

Compute resources 202 may include hardware components used to provide cloud services, such as general-purpose processors (e.g., central processing units (CPUs), server processors, accelerated processing units (APUs), controllers), specialized processors (e.g., graphics processing units (GPUs), application-specific integrated circuits (ASICs), digital signal processors (DSPs), field programmable gate arrays (FPGAs), neural network processing units (NPUs), data processor units (DPUs), controller cryptoprocessors (specialized processors for cryptographic algorithms)), or accelerators (e.g., graphics accelerators, compression accelerators, artificial intelligence accelerators), or other hardware components.

Storage resources 204 may provide the storage and retrieval of data (e.g., databases (including backups) or associated data). Storage resources 204 may include hardware, such as hard disk drives, solid-state drives, tape storage, or other suitable mechanisms for storing data. Storage resources 204 may store any suitable data in any suitable format(s). For example, storage resources 204 may provide object, block, or file storage. In various embodiments, storage resources 204 may include one or more database management systems (DBMS), such as relational databases (e.g., MySQL, PostgresSQL, SQL Server, Oracle Database, SQLite) and NoSQL data bases (e.g., MongoDB, Cassandra, Redis).

Operations computing systems 206 may include any suitable computing systems to manage the various operations of the backend, such as coordination of incoming and outgoing communications; allocation of compute, storage, and networking resources; monitoring of usage; application deployment; enforcement of security (e.g., identity and access management (IAM), encryption and key management, intrusion detection), and other management tasks.

Networking resources 208 may include any suitable hardware or software to facilitate communication among compute resources 202, storage resources 204, and/or other cloud resources of the backend. Networking resources 208 may include, e.g., routers, switches, firewalls, load balancers, gateways, edge devices, network interface cards, and other suitable networking hardware.

The compute resources 202, storage resources 204, and networking resources 208 may be used to provide compute services to clients of the service provider, such as virtual machines, containers, bare metal servers, or serverless computing.

In various embodiments, a backend 106 is managed by a third party. For example, a backend 106 may be deployed using a cloud service such as Amazon Web Services, Microsoft Azure, or Google Cloud Platform. A backend 106 may provide services to organizations using any suitable service model, such as infrastructure as a service (IaaS), platform as a service (PaaS), or software as a service (SaaS), or combinations thereof.

In IaaS, on-demand access is provided to essential information technology (IT) infrastructure, such as servers, storage, and networking, over a virtual interface. Users do not need to manage or maintain physical infrastructure, as it is hosted and managed by the cloud service provider. While the provider handles the underlying hardware and maintenance, users retain control over operating systems, storage, and applications they deploy. This eliminates the need for organizations to manage on-premises infrastructure, offering flexibility and scalability.

In PaaS, a development and deployment environment is provided, including the necessary infrastructure and software tools, for creating and managing applications. Users can develop and run cloud-based applications without managing the underlying infrastructure, such as servers, networks, and storage. PaaS is typically accessed on a pay-as-you-go basis and allows users to focus on application deployment and management, while the cloud provider handles the infrastructure and software maintenance.

In SaaS, users access cloud-based applications provided and maintained by a service provider. Instead of installing software locally, users access the applications via the web or application programming interface (API) on a subscription basis. In this model, the service provider oversees the hardware, software, middleware, and security, eliminating the need for end users to manage or update the software themselves.

An organization may utilize one or more backends 106 to provide application data backup for the organization. Application data backup is the process of creating a copy of application that can be used to restore an application (or data thereof) in case of data loss, corruption, or other disasters. Backups are essential for data protection, disaster recovery, and ensuring business continuity.

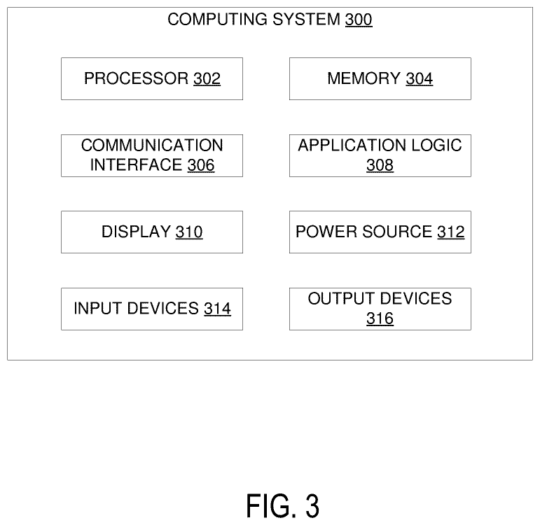

FIG. 3 illustrates a block diagram of a computing system 300, in accordance with any of the embodiments disclosed herein. One or more computing systems 300 (or portions or alternatives thereof) may be used to implement a computing system 102, a virtual computing system (e.g., including one or more applications to be backed up), one or more portions of backup and restore system 108, or one or more portions of backends 106. As used in this document, the term computing system is intended to encompass any suitable processing device. A computing system 300 may be operable to receive, transmit, process, store, or manage data and information associated with cloud backup environment 100.

In the depicted embodiment, computing system 300 includes one or more processors 302, memories 304, communication interfaces 306, application logic 308, display 310, power source 312, input devices 314, and output devices 316, among other hardware and software. These components may work together in order to provide any suitable functionality described herein.

A processor 302 may be any suitable computing device, resource, or combination of hardware, stored software and/or encoded logic operable to provide, either alone or in conjunction with other components of computing system 300, the functionality of the computing system. In particular embodiments, computing system 300 may utilize multiple processors to perform the functions described herein. In various embodiments, processor 302 may include one or more general-purpose processors (e.g., CPUS, server processors, APUs, controllers), specialized processors (e.g., GPUs, general-purpose GPUs, ASICs, DSPs, FPGAs, NPUs, DPUs, controller cryptoprocessors (specialized processors for cryptographic algorithms)), or accelerators (e.g., graphics accelerators, compression accelerators, artificial intelligence accelerators).

A processor can execute any type of instructions to achieve the operations detailed in this specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array (FPGA), an erasable programmable read only memory (EPROM), an electrically erasable programmable ROM (EEPROM)) or an application specific integrated circuit (ASIC) that includes digital logic, software, code, electronic instructions, or any suitable combination thereof.

Memory 304 may comprise any form of non-volatile or volatile memory including, without limitation, random access memory (RAM), read-only memory (ROM), magnetic media (e.g., one or more disk or tape drives), optical media, solid state memory (e.g., flash memory), removable media, or any other suitable local or remote memory component or components. Memory 304 may store any suitable data or information utilized by a computing system 300, including software embedded in a (e.g., non-transitory) computer readable medium, and/or encoded logic incorporated in hardware or otherwise stored (e.g., firmware). Memory 304 may also store the results and/or intermediate results of the various calculations and determinations performed by processor 302.

Communication interface 306 may be used for the communication of signaling and/or data between computing systems and one or more networks and/or network nodes coupled to a network or other communication channel. For example, communication interface 306 may be used to send and receive network traffic such as data packets. Each communication interface 306 may send and receive data and/or signals according to a distinct standard such as an LTE, IEEE 802.11, IEEE 802.3, or other suitable standard. In some instances, communication interface 306 may include antennae and other hardware for transmitting and receiving radio signals to and from other devices in connection with a wireless communication session over one or more networks.

Application logic 308 may include logic providing, at least in part, the functionality of the computing system (and may include application data, among other elements). In a particular embodiment, the logic of a computing system 300 may include software (e.g., a web browser, an application, an operating system, etc.) that is executed by processor 302. However, “logic” as used herein, may include but not be limited to hardware, firmware, software and/or combinations of each to perform a function(s) or an action(s), and/or to cause a function or action from another logic, method, and/or system. In various embodiments, logic may include a software controlled microprocessor, discrete logic (e.g., an application specific integrated circuit (ASIC)), a programmed logic device (e.g., a field programmable gate array (FPGA)), a memory device containing instructions, combinations of logic devices, or the like. Logic may include one or more gates, combinations of gates, or other circuit components. Logic may also be fully embodied as software.

Display 310 may include one or more embedded or connected (e.g., via a wired or wireless connection) external visual indicators, such as a computer monitor, a touchscreen display, a liquid crystal display (LCD), a light-emitting diode display, or a flat panel display.

Power source 312 may include one or more energy storage devices (e.g., batteries or capacitors) and/or circuitry for coupling components of the computing system 300 to an energy source separate from the computing system 300 (e.g., alternating current line power).

An input device 314 may accept input from a source external to the computing system 300. Examples of input devices 314 may include an image capture device, keyboard, cursor control device, touchscreen, and an audio device (e.g., microphone), to name a few.

An output device 316 may output signals based on information provided by computing system 300. Examples of output devices 316 include an audio device (e.g., a speaker), an audio codec, a video codec, a printer, a transmitter for providing information to other devices, a storage device, to name a few.

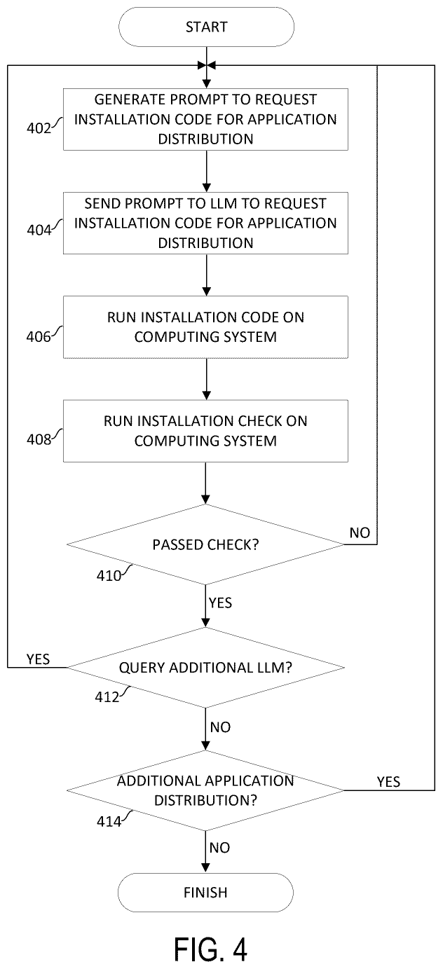

FIG. 4 illustrates a flow for generating application installers for an application, in accordance with any of the embodiments disclosed herein. The flow may be performed by any suitable logic of cloud backup environment 100 or other suitable logic. For example, the flow may be performed by one or more computing systems of backup and restore system 108. In one example, the flow is performed by installer generator 112, which is implemented by one or more computing systems. In various embodiments, any suitable operations of the flow may be performed by executing software implementing such operations.

At 402, a prompt to request installation code for an application distribution is generated. A prompt includes instructions that are to be provided to an LLM to guide the response of the LLM. In various embodiments, the prompt may include instructions to generate installation code for a particular distribution of an application. In some instances, the prompt may include a specification of the format (e.g., language) for the installation code to be returned by the LLM (e.g., Go, Python, etc.).

The prompt may include information identifying a distribution of the application, such as the name of the application, the version number of the application, the type of operating system upon which the application is to be installed (e.g., Microsoft Windows, macOS, Linux Ubuntu, Linux Fedora, etc.), the version number of the operating system upon which the application is to be installed, other suitable information associated with the distribution of the application, or suitable combinations of any of the preceding. When multiple distributions of an application that have the same version number are each to have installers generated, the prompt may include information identifying the specific distribution (e.g., different distributions may install the application in different directories or use or produce different installation files).

An example prompt is as follows: You are an installation helper assistant for servers, installing server software. You provide single line installation scripts one can use. You never use environment variables. When a version of an application exists in client/server variants you install the server version (e.g. install bitbucket server and not git for bitbucket). You always attempt to install the application. Provide an installation script to install MySQL 8.4 LTS in Linux Mint 22.1.

At 404, the prompt is sent to an LLM (e.g., over a network to one more servers that implement the LLM) to request installation code for the application distribution. In general, an LLM is a type of artificial intelligence (AI) trained on vast amounts of text data to understand and generate human-like language. An LLM works by predicting and generating text based on patterns learned from the training data. An LLM may be used for answering questions, writing, coding, summarizing, translating, and more. Examples of LLMs that may be used to provide functions described herein (e.g., identifying applications, generating application installation code, generating application detection code, etc.) include GPT-4 and GPT-3 by OpenAI; BERT, T5, PaLM, and LaMDA by Google; LLaMa and OPT by Meta; BLOOM by BigScience; Chinchilla by DeepMind; Turing-NLG by Microsoft; Megatron-LM by Nvidia; and DeepSeek by DeepSeek AI.

Responsive to the request, the LLM may provide an application installer comprising application installation code that is designed to be executable to install a specific distribution of an application in a particular computing environment. In one example, the code of the installer is a shell script to download and install the application using a tool (e.g., brew install, sudo apt install, etc.) selected based on the application and the operating system. In other examples, the installation code may be written in other suitable languages, such as python, etc. An example application installer that may be returned by an LLM responsive to the example prompt above is as follows: wget https://dev.mysql.com/get/mysql-apt-config_0.8.22-1_all.deb -O mysql-apt-config.deb && sudo dpkg -i mysql-apt-config.deb && sudo apt update && sudo apt install -y mysql-server.

At 406, the installation code of the application installer is run on a physical or virtual computing system (e.g., a virtual machine) that matches the environment for the application installer (e.g., a virtual machine running the specified version of the operating system for the application distribution).

At 408, an installation check is performed on the computing system (e.g., virtual machine) in an attempt to verify that the installation was performed successfully. In some instances, the installation check may comprise checking an application installation log at a file location associated with the application and may the installation check may pass if the application installation log does not contain any errors. In various embodiments, the installation check may additionally or alternatively involve running tests that invoke functionality of the application and determine whether the result matches the expected outcome. For example, for an application that is a database application, the installer generator 112 may check whether data can be written to and read from a database using the database application.

At 410, a determination is made as to whether the check has passed. If the installation check has not passed, the flow returns to 402. A modified prompt may be generated at 402. In various instances, all or a portion of the original prompt may be included in the modified prompt. In various instances, the modified prompt may include the installation code of the application installer as well as an indication that the installation code did not successfully install the application. In some instances, the updated prompt may include information describing why the installation check failed on the virtual machine (e.g., errors found in the installation log, lack of an installation log, lack of an expected installation file, etc.). The prompt may also include a request for the LLM to generate new installation code for the application installer. The modified prompt may be sent to the LLM at 404 and a new application installer is returned. The new installation code is then run on a virtual machine at 406 and the installation check is run again at 408. These operations may be looped through any number of times until the application installer passes the check. In some embodiments, at any suitable point, manual intervention may be requested to help generate the application installer. For example, if the installation check has failed a threshold number of times, a message may be provided to an administrator, and the administrator may intervene (either in manually updating the prompt or manually providing the application installer).

When the installation check has passed, the flow moves to 412, where a determination is made as to whether an additional LLM is to be queried to generate an additional application installer for the particular application distribution. For example, in some embodiments, the installer generator 112 may generate a plurality of application installers (each from installation code received from a different LLM) for a single application distribution in order to increase the diversity of application installers (thus improving the likelihood of generation of a functional application installer and/or increasing the number of configurations that may be used to test the application detectors).

For each LLM that is to generate installation code for the application distribution, the operations described above may be repeated. In various instances, the same prompt may be sent to each LLM. In some embodiments, if a prompt has been modified during the flow for a particular LLM, the modified prompt (or any suitable portion thereof) may be submitted to another LLM (as the additional information may allow the other LLM to more accurately generate the application installation code).

Once all of the application installers for the particular application distribution have been generated the flow moves to 414, where a determination as to whether application installers are to be generated for an additional application distribution. For example, one or more application installers may be generated for one or more other distributions of the application (e.g., for a different version number of the application, for a different operating system, etc.). If additional application installer(s) are to be generated for a different application distribution, the flow moves back to 402 and any number of LLMs may be used to generate application installers for this application distribution. When there are no remaining application distributions for which application installers are to be generated, the flow ends. In various embodiments, application installers to cover each of the installation distributions expected to be encountered in a backup environment are generated. The flow may be repeated for any number of different applications.

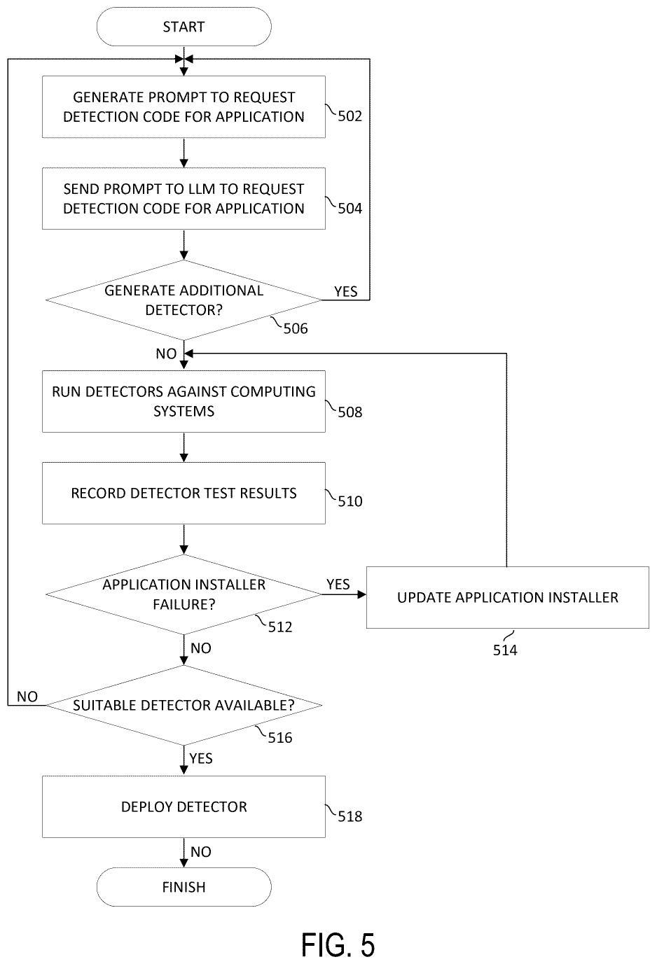

FIG. 5 illustrates a flow for generating a functional application detector for an application, in accordance with any of the embodiments disclosed herein. The flow may be performed by any suitable logic of cloud backup environment 100 or other suitable logic. For example, the flow may be performed by one or more computing systems of backup and restore system 108. In one example, the flow is performed by detector generator 114, which is implemented by one or more computing systems. In various embodiments, any suitable operations of the flow may be performed by executing software implementing such operations.

At 502, a prompt is generated to request detection code for an application. In various embodiments, the prompt may include instructions to generate detection code for an application. In some instances, the prompt may include a specification of the format (e.g., language) for the detection code to be returned by the LLM (e.g., Go, Python, etc.). The prompt may include information identifying the application (e.g., the application's name). In various embodiments, the prompt may also include information about the application distributions or potential installation environments in which the application may be installed (e.g., the prompt may request a detector that is capable of detecting installations of any number of distributions of the application within various different operating systems). In various embodiments, installation code of one or more (e.g., all) of the application installers for the various distributions of the application may be provided in the prompt for the detection code.

In some embodiments, a single application detector may be requested and generated for a variety of application distributions (as in the example below where the detector is to detect the application in both Windows and Linux environments). In other embodiments, separate application detectors may be requested (e.g., through separate prompts sent to an LLM) and created for the various application detectors (e.g., one detector for Windows environments, one detector for Linux environments, etc.). A detector may be generated for any suitable combination of application distributions (or for each distribution separately).

An example prompt for an application detector that may be sent to an LLM is as follows: You are an application classification bot. You create application classifiers for hard disks. Given a mounted hard disk that used to be on a server running a program you create golang code to detect if an application is installed on that hard drive or not. The hard drives might be from Windows machines or Linux machines so please deal with both cases. You MUST NOT import any packages. Your output is ONLY a classifier. go file that matches the following interface (you do not have to include the interface definition) in “package classifiers” located at ${classifier loc}:. You must write the classifier for ${applicationName}. You MUST NEVER output anything but the contents of classifier.go. You MUST implement the interface using value receivers. You MUST provide the most common installation paths for linux and windows. The windows drive is mounted at/eon/C:/ and the linux drive is mounted at/. You SHOULD include any common paths any versions of the application might be installed at.

At 504, the prompt is sent to an LLM (e.g., over a network to one more servers that implement the LLM) to request detection code for the application. In some instances, the LLM may be an LLM that also generated installation code for one or more distributions of the application. In other instances, the LLM may be a different LLM.

Responsive to the request, the LLM may provide an application detector comprising application detection code that is designed to be executable to detect an application installed in a computing environment (e.g., on a storage drive of a computing system, such as a storage drive of a virtual machine). The detection code may include instructions to perform any suitable functions facilitating detection of an application such as any of the functions described above. For example, the detection code may check for installation files at common paths (thus the prompt above includes an instruction to include common paths that the application may be installed at) or otherwise scan a file system for evidence that the application is installed. In other examples, the detection code may implement agent-based detection, scanning of configuration files, searching of a registry, monitoring of running processes, utilization of APIs, or other suitable detection functions. Thus, in some examples, an application detector may scan a file system of a computing system to search for configuration files, registry files, known installation files, and installation locations in order to detect if the application is installed. Additionally or alternatively, the application detector may attach into a running computing system to check processes running on the computing system or connect to known APIs based on the configuration files.

At 506, a determination is made as to whether an additional application detector (or set of application detectors for different distributions of an application) is to be generated for the application by querying an additional LLM (e.g., using the prompt or a modified prompt). In various embodiments, any number of LLMs may be queried to generate respective application detectors for a particular application, where each application detector includes detection code generated by a different LLM. If an additional application detector is to be generated, the flow returns to 502 where the same prompt (or a different prompt, e.g., adapted to the LLM to which the prompt is to be sent) is provided to another LLM for generation of an additional detector for the application (or set of detectors if more than one detector is desired for the various distributions of the application).

In some embodiments, once detection code has been generated by an LLM, an additional request may be sent to the LLM or to one or more other LLMs to verify at least a portion of the detection code. For example, the request may include a prompt as well as the detection code. An example prompt is as follows: The following is program code for detecting if ${applicationName} is installed on a hard disk. You MUST tell us if the paths the code uses are correct or not. If they are not correct, you MUST tell us what is wrong with them. In some instances, the detection code may be modified based on the response from the one or more LLMs (either manually or through requesting updated detection code from the LLM with a new prompt based on the results received from the one or more LLMs). In some embodiments, this additional request is not sent until after the detector has been tested and failed in some manner.

Once the detectors have been generated, the flow moves to 508 where the detectors are run against physical or virtual computing systems (e.g., virtual machines). That is, the detector code is executed on each of a plurality of computing systems. The computing systems may collectively have multiple distributions of the application installed thereon. In some embodiments, the computing systems may be the same computing systems that ran the application installers (and for which the installation checks passed) and thus already have one or more applications installed thereon. In various embodiments, the computing systems could additionally or alternatively include different computing systems (e.g., computing systems with one or more applications installed that were not installed via an application installer, computing systems with no applications installed, etc.). In various embodiments, the computing systems may collectively have any number of different distributions of the application installed on any number of different operating systems. The computing systems may also include at least one computing system that does not have the application installed thereon (e.g., these computing systems may have one or more other applications installed thereon, whether through application installers as described herein or via other means). In some instances, each computing system may have a single application installed on it (with a subset of the computing systems each including a different distribution of the application installed thereon and other computing systems each including one of a plurality of other applications installed thereon). In other instances, some of the computing systems may include a single application installed thereon while other computing systems include multiple applications installed thereon. In yet other instances, each of the computing systems may include a plurality of applications installed thereon. In some instances, one or more of the computing systems may have zero applications installed thereon.

An application detector may be run against any number of the computing systems. In various embodiments, each detector for a particular application may be run against the same set of computing systems. Example code for running the detector is as follows (which may be adapted for the particular execution environment in other embodiments): const code =fs.readFileSync(‘classifiers/${applicationName}. go’, “utf-8”); return’

When an application detector is run on a computing system, the detector produces an output indicating whether the application detector detected the application on the computing system. In some embodiments, when a detector detects the application, the detector may also generate an indication of the reason(s) the application was detected on the computing system. In various embodiments, when a detector does not detect the application, the detector may also generate an indication of the reason(s) the application was not detected on the computing system.

At 510, the detector test results (e.g., the outputs described above) are recorded. These detector test results may be indicative of whether the detectors are accurately detecting the application on computing systems on which the application is installed and not erroneously detecting the application on computing systems on which the application is not installed. In various embodiments, the test results may also be indicative of whether the applications were installed correctly using the application installers.

At 512, a determination is made as to whether the test results indicate an application installer failure. For example, if all (or a threshold number or percentage) of the detectors from the various LLMs fail to detect the application on a computing system that executed an application installer for a particular distribution of the application (or across multiple computing systems on which the application installer or other application installers for different distributions of the application were run), then the likelihood that the application did not install correctly (despite passing the installation check) may be high, and the application installer may be updated at 514. The updating may include sending a request to one or more LLMs (e.g., with an updated prompt including, e.g., the latest prompt for the LLM, the code of the application installer, an indication that the installation failed, information from the testing such as one or more reasons for the failure of the detection, etc.). One or more new application installers may then be generated through one or more LLMs and executed on one or more computing systems and then the flow may return to 508 and the detectors may be tested again.

If no changes to the application installers are to be made, the flow moves to 516 where a determination is made as to whether a suitable detector is available. For example, the results from each detector may be examined and if a particular detector has accurately detected the application on the computing systems on which the application was installed and accurately determined that the application was not installed on the computing systems on which the application was not installed, that detector may be determined to be suitable. In other embodiments, other suitable criteria may be used to determine whether a detector is suitable (e.g., if the detector has met a particular threshold for accurate detection). If multiple detectors are determined to be suitable, then one of the detectors may be selected based on any suitable criteria. In some instances, the first detector found to be suitable may be selected (and testing of the other detectors may be omitted in some embodiments). In another embodiment, among multiple suitable detectors, the detector that is the fastest to execute may be selected.

If a suitable detector is not available, the flow returns to 502, where the prompts sent to the LLMs are updated. For example, an updated prompt to be sent to a particular LLM may include any one or more of the previous prompt sent to the LLM to generate the detection code, the detection code, the installation code executed on a computing system on which the detector was run, an indication that the detector performed inaccurately (e.g., failed to detect the application on the computing system or detected the application on the computing system when the application wasn't installed on the computing system), one or more reasons that the detector used in its determination that the application was or was not installed on the computing system, or other suitable information. The detectors may be modified by the LLMs and tested again. The operations may be repeated any number of times until a suitable detector is available. In some embodiments, if the operations have been completed a threshold number of times without a suitable detector being generated, a prompt may be sent to an administrator including a notification of the failure.

After a suitable detector is selected, the flow moves to 518 where the detector is deployed. Deployment may include providing the detection code to a backup system (e.g., backup engine 110) for use in detecting the application on computing systems to be backed up (e.g., of one or more organizations served by the backup and restore system 108).

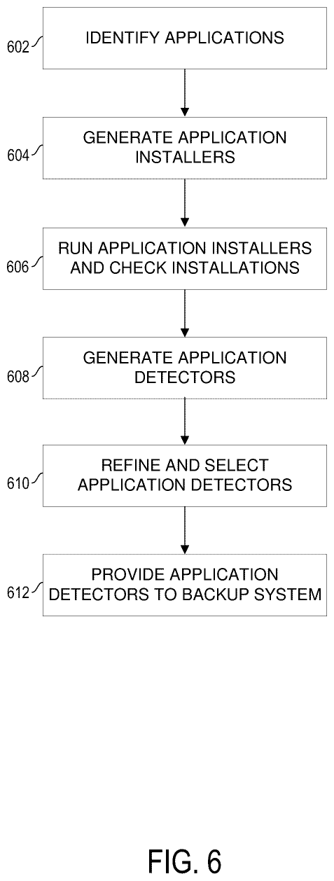

FIG. 6 illustrates a flow for generating application installers and application detectors, in accordance with any of the embodiments disclosed herein. The flow may be performed by any suitable logic of cloud backup environment 100 or other suitable logic. For example, the flow or any operations thereof may be performed by one or more computing systems of backup and restore system 108 (e.g., the same one or more computing systems that implement installer generator 112 and/or detector generator 114).

At 602, a plurality of applications are identified. These applications include the applications for which application installers and/or application detectors are to be generated. The applications may be identified in any suitable manner. For example, a list of applications may be generated using one or more LLMs. As an example, in order to generate identifications of applications, an LLM may be given one or more queries such as “give me a list of the 300 most popular applications you can install on linux” or “list the 100 most popular databases.” As an example, the latter query may generate results such as MySQL, PostgreSQL, Microsoft SQL Server, SQLite, MongoDB, Oracle Database, Redis, Elasticsearch, MariaDB, IBM Db2, Cassandra, Firebase Realtime Database, Amazon DynamoDB, Microsoft Access, Neo4j, and so on. In some instances, the query may ask for omission of applications that are cloud services that are not installed on individual computing systems (e.g., Amazon DynamoDB) or such applications may be filtered out of the results manually.

The results from one or more queries to one or more LLMs may be assimilated to form the plurality of application identifiers. In addition or as an alternative, one or more human administrators may manually supply or otherwise edit (or remove) identifications of applications (e.g., these may supplement or replace a list of applications assimilated from querying one or more LLMs).

In some instances, one or more LLMs may also be used to generate identifiers of multiple distributions (e.g., the most common distributions) for at least some of the applications. In addition or as an alternative, an administrator may supply the identifier of the distributions of the applications.

At 604, installer generator 112 may leverage one or more LLMs (e.g., as described above with respect to FIG. 4 or using suitable variations thereof) to generate a plurality of application installers for a plurality of applications (and distributions thereof).

At 606, the application installers are run on various computing systems (e.g., virtual machines) and the installations are checked (e.g., as described above with respect to FIG. 4 or using suitable variations thereof).

At 608, the detector generator 114 generates application detectors for the identified applications (e.g., as described above with respect to FIG. 5 or using suitable variations thereof). At 610, the application detectors are tested and refined based on the results (e.g., by sending additional requests to the LLMs) and then application detectors are selected for deployment (e.g., as described above with respect to FIG. 5 or using suitable variations thereof). At 612, the selected application detectors are provided to a backup system (e.g., backup engine 110) for use in backing up applications of various users of the backup system.

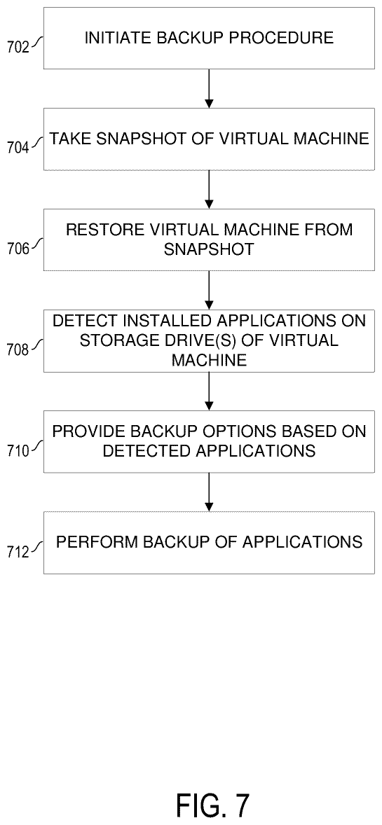

FIG. 7 illustrates a flow for utilizing application detectors to perform application backup, in accordance with any of the embodiments disclosed herein. The flow may be performed by any suitable logic of cloud backup environment 100 or other suitable logic. For example, the flow may be performed by one or more computing systems of backup and restore system 108. In various embodiments, any suitable operations of the flow may be performed by executing software implementing such operations. Although the flow is described with respect to backing up a virtual machine, the flow may be adapted to backup of any suitable physical or virtual computing system.

At 702, a backup procedure is initiated. In various examples, the backup procedure may be initiated responsive to a request from a user (e.g., for an immediate backup or for a regularly scheduled backup).

At 704, a snapshot of a virtual machine is performed. A snapshot may be a point-in-time copy of the virtual machine, including a memory state (e.g., if the virtual machine is running at the time of the snapshot), a disk state (e.g., including all data on the virtual hard drive), and the virtual machine configuration (e.g., settings such as CPU, memory, network, etc.). In some instances, the snapshot may include a subset of this information.

At 706, the virtual machine is restored from the snapshot (e.g., using a different computing system from the one running the virtual machine). This may allow the backup system to access the data of the virtual machine without disturbing the operating environment of the virtual machine.

At 708, installed applications on one or more storage drives of the virtual machine are detected using application detectors that have been generated and deployed as described above.

At 710, backup options may be provided based on the detected applications. For example, identifications of the detected applications are provided to a user (e.g., via an interface provided to a computing system 102 over the network 104 by the backup and restore system 108) who may then select (e.g., via the interface) which applications are to be backed up or otherwise set backup policies for the applications that are to be backed up. In some instances, the detected applications may be checked against specific applications or types of applications that are to be backed up according to a previously established policy. For example, a user may set a policy to back up computing systems (e.g., VMs) which run a specific application (e.g., mySQL) at a particular frequency (e.g., twice a day) to one or more particular storage locations. As another example, a user may set a policy to back up computing systems which run a specific type of application (e.g., database applications) at a particular frequency to one or more particular storage locations. The detectors may be executed at any suitable time to identify the computing systems that have applications that match the policy (e.g., the detectors are not necessarily executed during a backup procedure, but could be run before the backup procedure) and the results may be stored to facilitate future backups. For example, detectors may be run on one or more computing systems (e.g., responsive to a request from a user) and the detected applications may be presented to the user in any suitable format (e.g., in a list format, with the corresponding computing systems on which the applications were detected, etc.). The user may then select an application or group of applications and specify a backup policy for the application or group of applications. The policy may also specify the type of backup to be performed for a particular application or group of applications. For example, for computing systems on which a particular application is detected, the user may specify that the entire computing system (e.g., VM) is to be backed up, while for computing systems on which a different application (e.g., mySQL or other database) is detected, the user may set a backup policy to only back up specific data produced by the application (e.g., the database table data). As another example, for a computing system running mySQL or other database, the user could specify that the database table data be backed up (where this may be done, e.g., by breaking a table up into a set of files, such as parquet files) and to backup the VM without the database content. Then, upon receiving a restoration command for the VM, a VM may be created from the same distribution with the same database version and the database data may be restored to that VM.

At 712, backup of applications is performed. For example, files or other data generated by the installation of or use of the detected applications is backed up, e.g., at a location that is different from a storage location of the virtual machine (e.g., at a backend 106).

In some embodiments, the application detectors may be executed for purposes other than backing up the applications. For example, a user may simply desire to understand which computing systems are running a particular application or type of application or how many instances of a particular application are installed across a group of computing systems. Thus, an interface provided to a user may indicate which computing systems and/or how many computing systems are running a particular application responsive to running the detectors across a computing environment associated with the user.

It is important to note that the operations in FIGS. 4-7 illustrate only some of the possible scenarios that may be executed by, or within, the various components of the systems described herein. Some of these operations may be removed or repeated where appropriate, or these steps may be modified or changed considerably without departing from the scope of the present disclosure. In addition, the timing of these operations may be altered considerably. The preceding operational flows have been offered for purposes of example and discussion.

Logic can be used to implement the functionality of various components or to carry out the operations of the flows described herein. “Logic” may refer to hardware, firmware, software, or any combination of these to perform one or more functions. In some embodiments, logic may include a microprocessor or other processing elements capable of executing software instructions, discrete logic such as an application-specific integrated circuit (ASIC), a programmable logic device like a field-programmable gate array (FPGA), a storage device with recorded instructions, combinations of logic devices (e.g., on a printed circuit board), or other suitable hardware and software configurations. Logic may also include gates or other circuit components. In certain cases, logic may be entirely implemented as software. This software can take the form of packages, code, instruction sets, or data stored on a non-transitory computer-readable storage medium.

The embodiments of methods, hardware, software, firmware, or code described above may be implemented through instructions or code stored on a machine-accessible, machine-readable, computer-accessible, or computer-readable medium that can be executed by a processing element. A non-transitory machine-readable medium may refer to a mechanism that provides (e.g., stores and/or transmits) information in a format readable by a machine, such as a computer or electronic system. Examples of such non-transitory media include random-access memory (RAM), such as static RAM (SRAM) or dynamic RAM (DRAM); read-only memory (ROM); magnetic or optical storage media; flash storage devices; electrical and optical storage devices; acoustical storage devices; and other forms of storage devices that retain information obtained from transitory (propagated) signals (e.g., carrier waves, infrared signals, digital signals). These non-transitory media are distinct from the transitory signals themselves, which may provide information to the storage media.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. For example, the phrase “A and/or B” means (A), (B), or (A and B), while the phrase “A, B, and/or C” means (A), (B), (C), (A and B), (A and C), (B and C), or (A, B, and C).

As used throughout this description, and in the claims, a list of items joined by the term “at least one of” or “one or more of” can mean any combination of the listed terms.

What is claimed is:

1. A method, comprising:
receiving, from a plurality of large language models, a first plurality of application detectors for a plurality of applications, wherein an application detector comprises executable code to detect whether an application is installed on a computing system;
executing the first plurality of application detectors to determine whether the first plurality of application detectors accurately detect applications installed on a plurality of computing systems; and
selecting, based on detection accuracy of the first plurality of application detectors, a second plurality of application detectors to deploy for use in detecting the plurality of applications.

2. The method of claim 1, further comprising modifying a prompt provided to a first large language model of the plurality of large language models, the modified prompt to request an application detector from the first large language model for a first application of the plurality of applications, wherein the prompt is modified responsive to a determination that application detectors for the first application are not suitable for deployment.

3. The method of claim 2, wherein the modified prompt comprises the executable code of the application detector and an indication that the application detector was inaccurate.

4. The method of claim 2, wherein the modified prompt comprises installation code for the first application.

5. The method of claim 1, further comprising receiving, from a large language model of the plurality of large language models, an application installer for a first application of the plurality of applications, wherein the application installer comprises executable code designed to install a distribution of the application on a computing system.

6. The method of claim 5, further comprising executing the application installer on a first computing system.

7. The method of claim 6, further comprising modifying a prompt provided to the large language model to request the application installer for the first application, wherein the prompt is modified responsive to a determination that the first application was not installed successfully on the first computing system.

8. The method of claim 1, further comprising executing the second plurality of application detectors responsive to initiation of a backup for a computing system.

9. The method of claim 1, wherein the plurality of computing systems are a plurality of virtual machines.

10. The method of claim 1, further comprising generating a prompt to request a first application detector from a large language model of the plurality of large language models, wherein the prompt includes an identifier of the first application detector.

11. An apparatus comprising:
a communication interface to:
send requests to a plurality of large language models; and
receive, from the plurality of large language models, a first plurality of application detectors for a plurality of applications, wherein an application detector comprises executable code to detect whether an application is installed on a computing system; and
at least one processor to:
execute the first plurality of application detectors to determine whether the first plurality of application detectors accurately detect applications installed on a plurality of computing systems; and
select, based on detection accuracy of the first plurality of application detectors, a second plurality of application detectors to deploy for use in detecting the plurality of applications.

12. The apparatus of claim 11, the at least one processor to modify a prompt provided to a first large language model of the plurality of large language models to request an application detector from the first large language model for a first application of the plurality of applications, wherein the prompt is modified responsive to a determination that application detectors for the first application are not suitable for deployment.

13. The apparatus of claim 11, the communication interface to receive, from a large language model of the plurality of large language models, an application installer for a first application of the plurality of applications, wherein the application installer comprises executable code designed to install a distribution of the application on a computing system.

14. The apparatus of claim 13, the at least one processor to execute the application installer on a first virtual machine.

15. The apparatus of claim 14, the at least one processor to modify a prompt provided to a large language model of the plurality of large language models to request an application installer for the first application, wherein the prompt is modified responsive to a determination that the first application was not installed successfully on the first computing system.

16. At least one computer-readable non-transitory media comprising one or more instructions that when executed by at least one processor configure the at least one processor to cause performance of operations comprising:
receiving, from a plurality of large language models, a first plurality of application detectors for a plurality of applications, wherein an application detector comprises executable code to detect whether an application is installed on a computing system;
executing the first plurality of application detectors to determine whether the first plurality of application detectors accurately detect applications installed on a plurality of computing systems; and
selecting, based on detection accuracy of the first plurality of application detectors, a second plurality of application detectors to deploy for use in detecting the plurality of applications.

17. The at least one media of claim 16, the operations further comprising modifying a prompt provided to a first large language model of the plurality of large language models to request an application detector from the first large language model for a first application of the plurality of applications, wherein the prompt is modified responsive to a determination that application detectors for the first application are not suitable for deployment.

18. The at least one media of claim 16, the operations further comprising receiving, from a large language model of the plurality of large language models, an application installer for a first application of the plurality of applications, wherein the application installer comprises executable code designed to install a distribution of the application on a computing system.

19. The at least one media of claim 16, the operations further comprising:
executing the second plurality of application detectors to determine at least one application installed on at least one computing system;
providing an indication of the at least one application for display to a user via an interface; and
receiving, via the interface, a backup policy associated with the at least one application.

20. The at least one media of claim 16, the operations further comprising executing the second plurality of application detectors responsive to initiation of a backup of a computing system.
